(19) United States
(12) Patent Application Publication
(10) Pub. No.: US 2014/0183900 A1
(43) Pub. Date: Jul. 3, 2014

(54) RAPID DEPLOYMENT COVERING SYSTEM AND METHOD

(71) Applicant: Coil Cap, Inc., Columbus, IN (US)

(72) Inventors: Matthew W. Mobley, Madison, IN (US); Joseph W. Mobley, Madison, IN (US); David W. Mobley, Hartsville, IN (US)

(73) Assignee: Coil Cap, Inc., Columbus, IN (US)

(21) Appl. No.: 13/956,114

(22) Filed: Jul. 31, 2013

Related U.S. Application Data
(60) Provisional application No. 61/677,679, filed on Jul. 31, 2012.

(51) Int. Cl. B60P 7/04

(52) U.S. Cl. CPC B60P 7/04
USPC 296/100.14

(57) ABSTRACT

A load covering device includes two opposing hinge boxes, each hinge box having a pair of structural plates. Each of the pair of structural plates defines a matched progression of holes, the matched progression of holes having two terminal holes and at least one central hole. The device includes a number of rib members, each having two ends, with one end interposed between and pivotally coupled to corresponding holes of the structural plates of each hinge box. A rib member having ends positioned at one of the terminal holes in each of the hinge boxes is a terminal rib member, and the terminal rib member includes a fixed bend, the fixed bend being in a plane parallel to the structural plates.

### RELATED APPLICATIONS

This application is related to, and claims priority to, U.S. Provisional Patent Application 61/677,679 entitled RAPID DEPLOYMENT COVERING SYSTEM AND METHOD, filed Jul. 31, 2012, and which is included herein by reference for all purposes in the entirety.

### BACKGROUND

The technical field generally relates to load covering systems, and more particularly but not exclusively to load covering systems for vehicle loads.

Presently known vehicle load covering systems suffer from a number of drawbacks. Often loads will be covered with a tarp. Tarp coverage is time consuming and subject to variability in the final load coverage. Additionally, loose portions of the tarp, and/or portions of the tarp that are in contact with an edge or sharp surface of the load will suffer inordinate wear and require replacement before the scheduled service life of the tarp.

Commercial drivers are subject to driving time regulations. Drivers may only drive a number of hours per day, and may only work a specified total amount of time per day. Time that is spent doing other work outside of driving can limit the number of hours the driver is on the road moving the vehicle, and can make the driver incrementally more tired and less aware while on the road due to fatigue. Any time spent working that is not moving the vehicle is unproductive time where the driver is not getting paid, and/or an employer is not realizing a commercial benefit from the special skills of the driver.

Commercial vehicles are wide enough such that one person typically cannot reach both sides of a load at the same time. Often, properly covering and securing a load requires more than one person. Even where more than one person is not required, it can be inordinately time consuming to properly cover and secure a load with one person.

Canopy or dome type load covering devices are known in the art. Previously known canopy or dome type load covering devices suffer from one or more of the following drawbacks: a lack of solid framing in contact with the load bed all the way around the covered device; a multitude of securing points required, and/or securing points introducing point-stresses on a cover; securing operations required on multiple sides of the covering device; manual deployment of a cover separate from the deployment of a supporting frame; a frame shape that limits potential load or coverage shapes; and a slow or cumbersome deployment mechanism. Therefore, further technological developments are desirable in this area.

### BRIEF DESCRIPTION OF THE DRAWINGS

FIG. 1 is a schematic diagram of a hinge box in a side view.

FIG. 2 is a schematic diagram of a hinge box in a perspective view.

FIG. 3 is a schematic diagram of a covering device in a stored position.

FIG. 4 is a schematic diagram of a covering device in a deployed position.

FIG. 5 is a schematic illustration of a portion of a covering device including support straps.

FIG. 6 is a schematic illustration of a portion of a covering device including an alternate configuration of support straps.

FIG. 7 is a schematic diagram of a covering device including a cover and an integrated cover loop and a securing device.

FIG. 8 is a schematic diagram illustrating a strap loop and a securing device.

FIG. 9 is a schematic diagram depicting an alternate arrangement for rib members of a covering device.

FIG. 10 is a schematic diagram of an embodiment of a hinge box with a structural plate in transparent view.

FIG. 11 is a schematic diagram of the hinge box depicted in FIG. 10.

FIG. 12 is a schematic diagram of an embodiment of a covering device.

FIG. 13 is a schematic diagram of a covering device having a securing flap.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

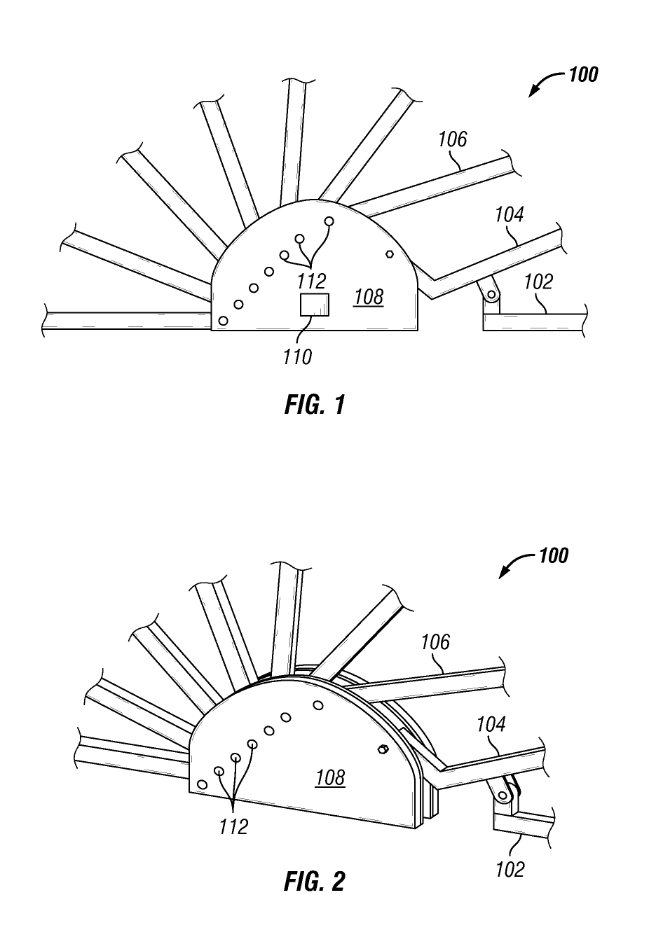

FIG. 1 is a schematic diagram of a hinge box in a side view. In the example of FIG. 1, a number of rib members 102, 104 are illustrated as coupled to the hinge box. The rib members 102, 104 have an end pivotally coupled to the hinge box at the position of the holes 112 illustrated in the sides of the box. The coupling mechanism may be any mechanism understood in the art, including rivets, bolts, a barrel bolt, or other fastener passing through two opposing structural plates of the hinge box and the rib 102, 104. The hinge box is provided as a matched pair, with an opposing hinge box (not shown), and the two hinge boxes together define a width of a load area, or an area to be covered by a covering device including the hinge boxes as a part of the device 100. The rib members 102, 104 are coupled to both hinge boxes, in corresponding holes 112, and progress between the hinge boxes in any geometry desired and applicable to the load.

A preferred, but non-limiting, example includes the rib members being straight in the plane of the structural plates 108 of the hinge boxes until the shape of the load area is defined. For example if a load is 8 feet long and 6 feet high, the rib members at the ends will be at least 4 feet long each in the plane of the structural plates, providing a covering device that exceeds the 8 feet long by a desired amount, and the more central rib members will be at least six feet high in the plane of the structural plates. The rib members 102, 104 may traverse the load width with a bowed shape, a squared shape, or a squared shape with rounded corners, etc.

The cross sectional shape of the rib members may be any desired shape. In certain embodiments, the cross sectional shape of the rib members is rectangular or squared. However, any shape including at least round, triangular, an irregular shape, etc. is contemplated herein. An example shape includes the end rib members (the far right and far left rib members) having a flattened shape on the portion that lands on the loading bed.

The material of the rib members may be any desired material, and may depend upon the constraints of the application. In many applications, weight is a limitation because weight of the covering device competes for the maximum allowable load weight, and because a heavier covering device is more difficult for a single person to readily manipulate. However, vibrational and/or strength considerations may require a heavier material to be utilized. Without limitation, in certain embodiments, the material for the rib members includes aluminum, steel, stainless steel, plastic, wood, and/or titanium.

The overall shape of a covering device 100 with the hinge boxes and the rib members is selectable according to the load or the covered area. Example and non-limiting load or covered areas include metal coils for transport, for example aluminum or steel coils. Covering devices sufficiently sized for maximum weight (e.g. due to road regulations) steel coils can be readily created, and covering devices sufficiently sized for a pair of steel coils can be readily created without creating a covering device that is prohibitively high for transport on a standard commercial vehicle. Certain applications, of course, do not have a transport size limit and are also contemplated herein. In certain embodiments, a covering device is of a size and shape suitable for a pickup bed, covering a boat top and/or boat cockpit area, and/or covering a load of any type (cylindrical or other shapes).

The hinge box includes the structural plate 108 defining a progression of holes 112 thereupon. In the example, the holes are monotonically increasing in vertical height, except for one of the end holes (the hole on the right in FIG. 1) which is lower than an adjacent hole. The description herein of “increasing in vertical height” refers to the orientation of the hinge box as depicted in FIG. 1, and is not limiting to the final orientation of a covering device 100 using the hinge box, which may be in any direction as defined by the load and/or the covered area. For example, and without limitation, the covering device 100 may be installed on a slanted portion of a boat and/or a trailer.

The example of FIG. 1 includes one of the end rib members 104 having a fixed bend in the rib member. The fixed bend is angled such that, when the covering device is fully deployed, for example when the rib members are spread to a maximal extent, the end rib member 104 (or the additional rib member 102 attached to the end rib member in the example of FIG. 1) lays flat on the load bed. The load bed, for the purposes of the end rib member laying flat, can include a trailer bed, a pickup side wall, a boat sidewall or cockpit area, and/or a receiving area such as an angled ridge or trough constructed for receiving the end rib member. Without being limited to a particular theory of improvement, the rib member laying flat onto the load bed greatly simplifies the securing of the load because the structural rib member 102 holds a cover (e.g. a tarp—not shown) directly to the load bed, greatly increases the service life of the cover, and greatly reduces the load securing time. By contrast, a configuration providing a significant portion of only soft cover in contact with the load bed results in a configuration requiring the securing of the soft cover material in multiple positions to ensure the load is properly protected, and increases wear on the soft cover as securing devices attach directly to the soft cover.

Embodiments wherein the end rib members lay flat on the load bed are not limited to the end rib members landing horizontally with respect to the hinge box. Although in a typical load, the hinge box may be positioned on a horizontal bed, and the end rib members may land horizontally to the hinge box, it is also possible that the covering device on either side of the hinge box may engage a tilted surface, for example a rising portion of a trailer and/or a boat cockpit area. Accordingly, the angle of the fixed bend and the position of the end holes of the hinge box are selected to ensure the end rib members lay flat on the contemplated load bed area for whatever is indicated by the application. In certain embodiments, the fixed angle may be adjustable to accommodate various application configurations. In such embodiments, the “fixed angle” refers to the covering device in use—for example a detent pin or other adjustment device may allow for adjustment of the angle of the end rib member, but the adjusted angle may be a “fixed angle” in regular use on the same application.

In the example of FIG. 1, the end rib member 104 includes a branch, also at a fixed angle (which may also be adjustable as described above) with a hinged additional rib member 102 attached thereto. In the example of FIG. 1, where an end member includes a flat surface for landing on the load bed, additionally or alternatively the additional rib member may include a flat surface where the additional rib member is the landing rib member on the load bed. In the example of FIG. 1, the additional rib member 102 is on a freely moving hinge. The selection of the branch angle and length, the fixed angle of the end rib member (the one directly coupled to the hinge box at the far right), the hinge point for the additional rib member, and any fixed angle or lack thereof applied to the additional rib member are selected such that the landing rib member lays flat on the load bed, and such that all of the rib members lay substantially flat together when the covering device is in an undeployed or stored condition.

The rib members that are straight and pivotally coupled to the monotonically rising holes progressing on the hinge box are readily prepared to lay flat. The positioning of the holes is provided to allow for the rib members to be directed to the final deployed angle, while being spaced according to the thickness of the rib members such that they lay substantially flat. The end member having the fixed angle is provided to allow the end member to lay substantially flat on the stack of straight rib members in the stored position. One of skill in the art, having the benefit of the disclosures herein and having information that is readily available for a specific application, such as the load size and covering device size, and the angles required to lay flat on the load bed, can readily select a final hole position and fixed angle such that the end rib member lays flat on the bed and the stack of rib member in the stored position is substantially flat. Additionally, in an embodiment including the branch and additional rib member, it is a mechanical step for one of skill in the art, having the benefit of the disclosures herein, to select a branch angle and length such that the additional rib member lays flat on the bed and substantially flat on top of the end member from which it branches in the stored position.

The degree of flatness for the stacked rib members in the stored position that constitutes “substantially flat” is dependent upon the specific application and is known to one of skill in the art for a specific application having the benefit of the disclosures herein. In certain embodiments, substantially flat includes stacked rib members that are lower than a specified height for the application, such as low enough that a pickup rearview mirror can see over the stack, lower than 2 feet, lower than 3 feet, and/or not higher than a protruding portion of a trailer. In certain embodiments, substantially flat includes stacked rib members providing surface at the top of the stack that is level or substantially level, for example level, within 1° of level, within 5° of level, and/or within 15° of level. In certain embodiments, substantially flat includes stacked rib members that provide a total stack height of the rib members that is within a specified tolerance of an ideal stack height. An ideal stack height is the sum of the rib member thicknesses (which may be the same or not), and substantially flat includes a total stack height that is equal to the ideal stack height, within 5% of the ideal stack height, within 10% of the ideal stack height, or within 25% of the ideal stack height. The described examples of substantially flat for the stacked rib members are non-limiting examples.

Referencing FIG. 2, a portion of a hinge box is depicted in a perspective view. The hinge box is seen to include two opposing structural plates 108. In the example of FIG. 2, a friction reducing sleeve is provided in the hinge box. The example friction reducing sleeve is a friction reducing material provided on the inner surfaces of the structural plates 108, at least in the area where the rib members are moving in contact with the hinge box. The inclusion of a friction reducing sleeve is optional and non-limiting. Any friction reducing material known in the art may be utilized, including at least a plastic, neoprene, PTFE (e.g. Teflon®), and/or any material that is softer than the material of the rib members 104, 106.

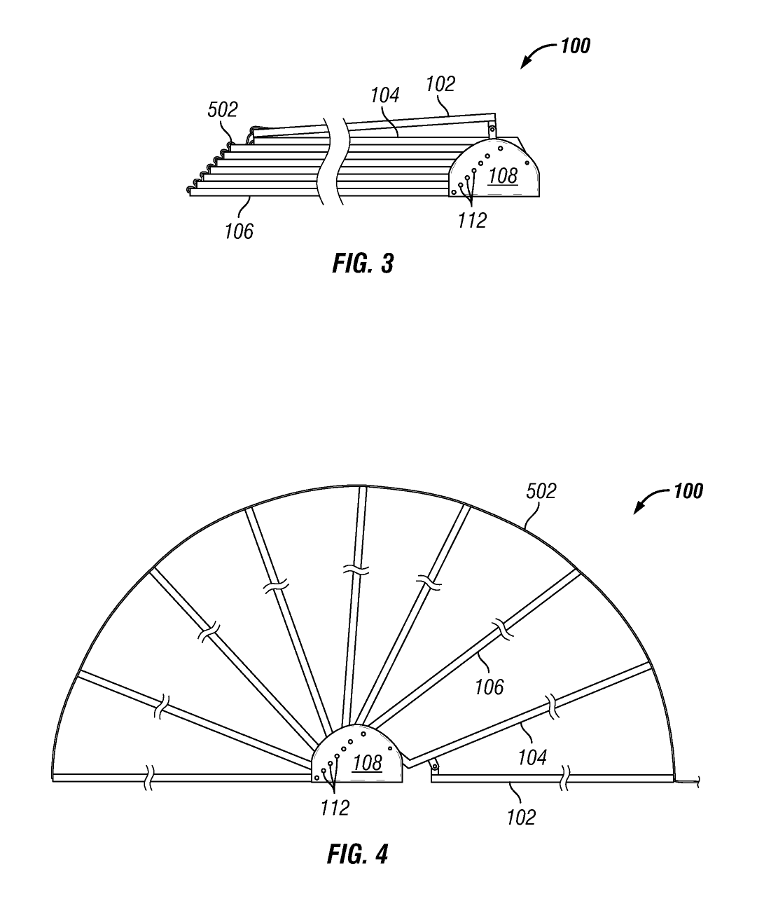

Referencing FIG. 3, a covering device 300 (except for a cover or tarp portion—not shown) is depicted in a stored position where the rib members 102, 104, 106 are laying substantially flat. The cover or tarp, which may be included as a part of the covering device, is omitted to more clearly illustrate one example of the way the rib members lay in the stored position. Support straps 502 coupling each of the rib members are visible.

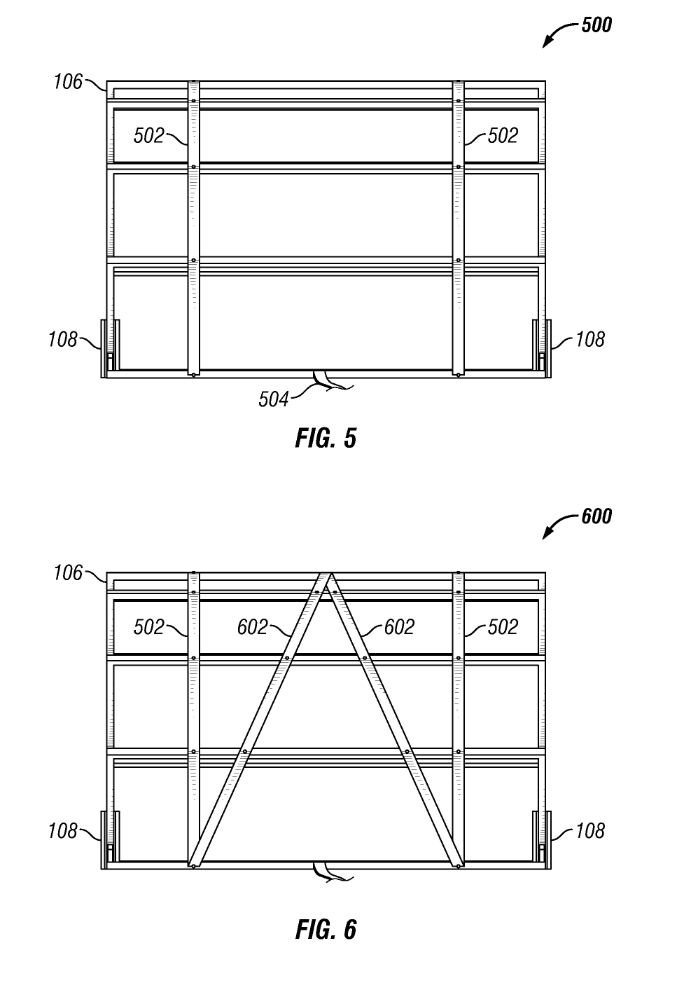

Referencing FIG. 4, a covering device is depicted in a deployed position where the end rib members (and/or additional rib member 102 coupled to the end rib member 104) are laying flat on a load bed (not shown). The load bed in the example of FIG. 4 is horizontal relative to the hinge box. In the example of FIG. 4, each of the rib members is attached to an adjacent rib member with two support straps 502. The support straps 502 are flexible, and can be any material. In certain embodiments, the support straps are standard load strap material which provides for ready availability of replacement straps. Referencing FIG. 5, a limited view of the rib members showing support straps 502 is depicted. The support straps 502 are distributed (spaced apart) in the load width direction, and may be distributed by at least 20%, 30%, 50%, or more of the total load width and/or the width of the covering device. Referencing FIG. 6, an additional or alternative embodiment of the support straps 502 is depicted. In the example of FIG. 6, the cover device includes diagonal support straps 602, where each of the diagonal support straps 602 is coupled to each of the rib members at a progressing position, where the progressing position is in the load width direction.

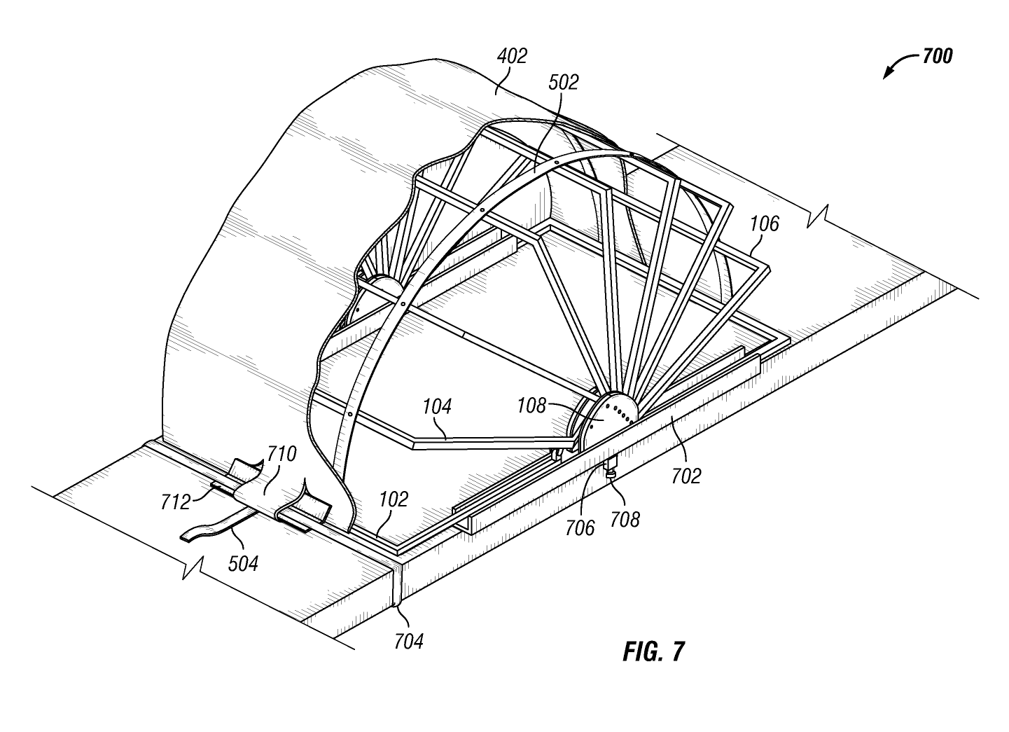

In one example, an end rib member at one side is affixed to a load bed, and the end rib member at the opposite side (e.g. the additional member 102) has a centrally located handle strap (not shown) affixed thereto. In certain embodiments, the hinge boxes 108 include a pocket stake 708 (e.g. see FIG. 7) or other feature allowing the hinge box to securely attach to the load bed. Additionally or alternatively, the hinge boxes 108 include a stake pocket 110 that receives a stake to secure the device 100 to a load bed. Additionally or alternatively, the fixed side of the covering device (e.g. one side of the device 100 fixedly secured to the load bed, with the rest of the device pivoting into position over a load), where present, may also include a pocket stake or other securing feature. For example, where one end rib member is fixed to the load bed, that end rib member may include a pocket stake or other feature, and the opposing end member may include a pull strap 504.

An operator can rapidly move the covering device between the stored and deployed positions with the handle strap 504. Each rib member follows the adjacent rib member through the forces applied through the support straps 502 while going from stored to deployed. Going from deployed to stored, the operator only lifts the first rib and incrementally more ribs until the covering device begins to fold into the stored position due to the weight of the ribs closer to the stored side. A covering device 100 substantially similar to that illustrated in FIG. 4 has been tested experimentally, and a single operator can readily move the device between the stored and deployed positions with a single hand in a matter of a few seconds. The presence of a handle strap 504 is optional and non-limiting. The covering device in FIG. 4 does not depict a cover or tarp to more clearly illustrate the position and operation of the rib members. In certain embodiments, the covering device includes a cover 402 (e.g. see FIG. 7) or tarp coupled to one or more of the rib members, or to all of the rib members, and configured such that in the deployed position the load or protected area within the covering device is fully protected according to the requirements of the load. The cover or tarp may be an integral cover with the covering device.

FIG. 7 is a schematic diagram 700 of a covering device including a cover and an integrated cover loop 710 and a securing device 712. The embodiment of FIG. 7 includes the securing device as a piece of angle metal 712 coupled to a terminal rib 102, which may be the end rib on the side shown or an additional rib coupled to the end rib. The securing device 700 provides a surface for a load strap to secure the covering device 700 to the load bed. In the example, the cover 402 or tarp of the covering device includes an integrated cover loop 710 which cooperates with the securing device 712 to provide a passage for the load strap 704 to pass through for securing. In the example of FIG. 7, the side opposite the integrated cover loop is affixed to the load bed. It can be seen in the embodiment of FIG. 7 that a single operator can cover and secure a load rapidly utilizing a single load strap from the same side of the load that the covering device is deployed from. Accordingly, an operator can cover and secure the load in perhaps a minute and not having to move more than a few feet in any direction. Additionally, the load is secured without any tie downs or time consuming attachment devices, and without any devices directly attaching to or putting stress on the cover/tarp of the covering device.

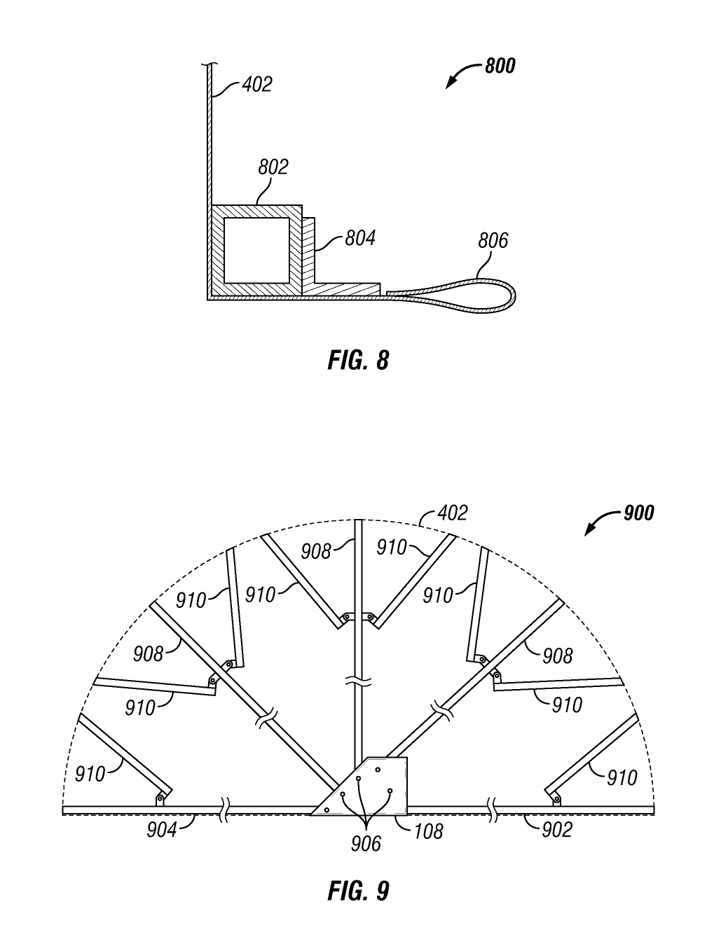

Referencing FIG. 8, an alternate embodiment 800 of a strap loop and securing device is depicted. In the embodiment 800, the cover/tarp is 808, and a pull strap 806 is formed as a portion of the cover/tarp 808. Additionally or alternatively, the pull strap 806 may be a separately attached device, such as a portion of a load strap. The pull strap 806 forms a loop sized to receive a load strap therethrough, although the loop is optional and non-limiting. The end rib member 802 (and/or additional rib member attached to an end rib member) is depicted in square cross-sectional shape, and has a securing device 804 attached thereto or integrated therewith. The securing device 804 is depicted as an attached angle metal piece. In the embodiment of FIG. 8, a load strap may be positioned directly onto the securing device 804, and/or the pull strap 806 may be folded back over the securing device 804 and the load strap passed therethrough. An embodiment such as that shown in FIG. 8 allows for the ready securing of the pull strap. Additionally or alternatively, the loop 806 may be wider than just a pull strap width, up to an including an entire width of the tarp/cover 808. In certain embodiment, the loop 806 may be provided intermittently at several locations across the width of the tarp/cover 808, providing increased securing of the tarp/cover 808 while also providing for ease of deployment of the load strap. Additionally or alternatively, and excess flap portion of the pull strap and/or tarp/cover 808, having a loop or not, may be folded over the securing device 804 and the load strap may be positioned over the folded flap and the securing device 804.

Referencing FIG. 9, and alternate embodiment 900 of the rib members 908 is depicted. The end-most rib members lay flat in the deployed position as illustrated. The rib members 908 lay substantially flat in the stored position. The branched additional rib members 910 provide for a hinge box having a reduced number of holes and pivot points, and allow for a somewhat simplified progression 906 of the holes. Additionally, the hinge box may be somewhat smaller with the reduced number of holes, where a smaller hinge box is desired. In certain embodiments, a smaller hinge box is not desired. A terminal rib member includes a fixed angle as depicted in FIG. 9. It is a mechanical step for one of skill in the art to select the hole progression 906, and the terminal rib member configuration including the fixed angle, such that the rib members lay substantially flat in the stored position, and such that the end rib members lay flat on the load bed.

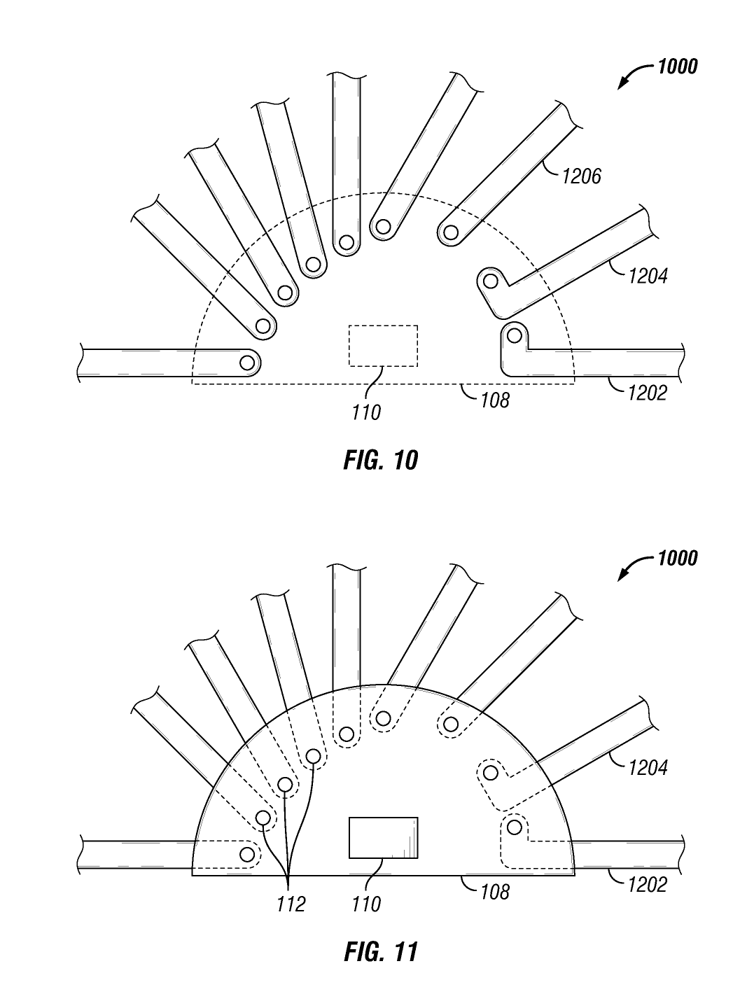

FIG. 10 is a schematic diagram of a device 1000 including a hinge box with a structural plate in transparent view. The device 1000 includes a number of rib members 1202, 1204, 1206 pivotally coupled to the hinge box. An end one of the rib members 1202 includes a fixed bend therein, which allows for the pivoting hole to be higher than the vertical bottom of the support plate, but the end rib member 1202 to lay flat on the load deck. A second rib member 1204 adjacent to the end rib member 1202 also include a fixed bend, allowing for the hole arrangement where a number of holes are monotonically rising (left 7 holes, in the example) with the last two holes (fixing 1202, 1204) are not rising. When all of the rib members are closed (laid over to the left) the arrangement of holes and fixed bends allows the entire set of ribs to lay substantially flat. The fixed bends are positioned entirely between the structural plates of the hinge box. In certain embodiments, this reduces odd wear forces on the ribs 1202, 1204 increasing the service life, and leaves simpler surfaces of the ribs 1202, 1204 exposed to avoid snagging materials, etc.

In certain embodiments, the further most rib to the left in FIG. 10 may be fixed to the load bed in a permanent or semi-permanent manner, and the ribs to the right pivot. In certain embodiments, the end rib 1202 is mechanically coupled to a pull strap, allowing the end rib 1202 to lead the motion of the ribs when opening or closing. The example device 1000 includes a stake pocket 110 coupled to the outer structural plate, allowing for easy securing of the device 1000 to a load bed. Additionally or alternatively, the device 1000 may include a pocket stake (e.g. see FIG. 7) or other device for securing. It is envisioned that the hinge boxes include two opposing structural plates that secure the pivoting ribs 1202, 1204, 1206, and that the device 1000 includes an opposing pair of hinge boxes that straddle the load area. The ribs 1202, 1204, 1206 progress between the hinge boxes in a selected manner, and the ribs are coupled to each hinge box at the respective ends of the ribs.

Referencing FIG. 11, another view of the device 1000 is depicted with the structural plate shown. The progression of the holes 112, with holes coupled to straight ribs monotonically rising, and holes coupled to ribs having a fixed bend not rising. It can be seen that the structural plate defines the entire bend, such that the bends are within the structural plates—although this feature is optional and non-limiting. The structural plates need only define the hole areas 112, and need not be a smooth or regular shape, although good engineering design, management of stresses in the structural plates, and reduction of sharp corners that can injure operators or tear materials contacting the structural plates may indicate that smooth and regular shapes are indicated in certain embodiments. The structural plate may be symmetrical, but need not be.

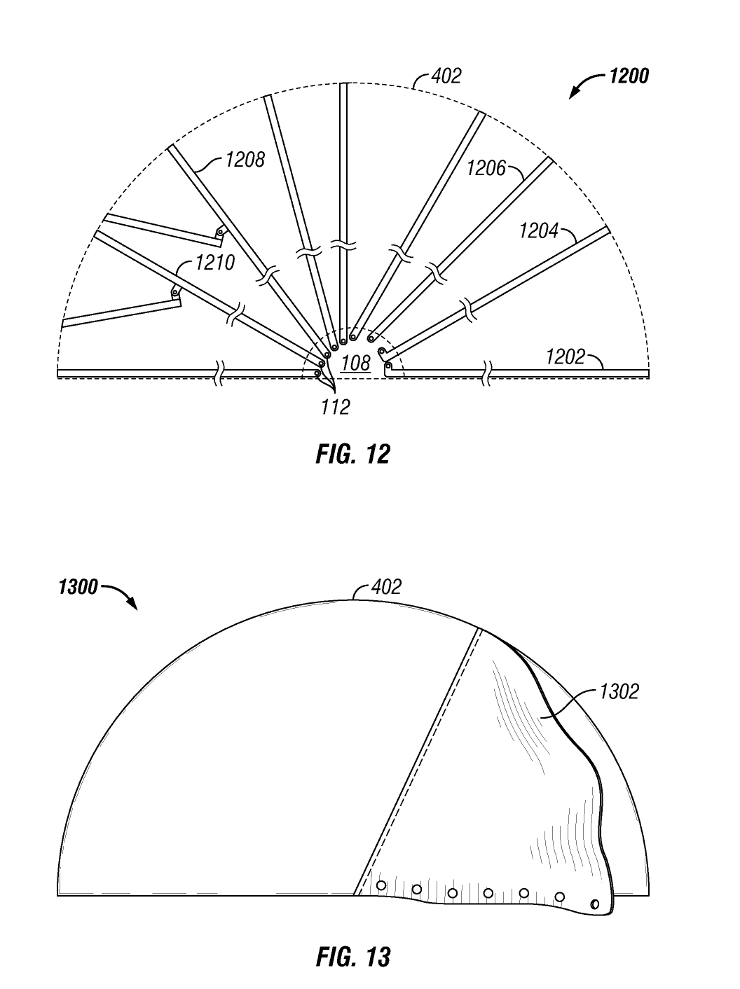

FIG. 12 is a schematic diagram of an embodiment of a covering device 1200. The device includes a tarp 402 shown schematically to illustrate certain principles described herein. The device 1200 includes an end rib 1202 and a rib adjacent to the end rib 1204 each having a fixed bend therein. The device 1200 further includes a second rib 1210 adjacent to a second end rib which is opposite the end rib 1202, where the second rib includes a pivotally coupled branch member. The device 1200 further includes a third rib 1208 adjacent to the second rib 1210, the third rib further includes a pivotally coupled branch member. The position and angle of the pivotally coupled branch member is selectable, with a position about halfway along the rib 1208, 1210 being depicted as an example. It will be understood that positions closer to the hinge box end will allow for an easier lay down and storage of the device 1200, while positions away from the hinge box end will allow for the use of less material in the pivoting branch. Positions of at least one-quarter of the way, at least one-third of the way, at least one-half of the way, and/or at least two-thirds of the way from the end away from the hinge box toward the hinge box are contemplated as example positions. The branched ribs attached to the tarp 402 provide a higher density of tarp contact points on the left side of the device 1200 than on the right side of the device 1200.

In certain embodiments, the left side of the device faces the front of a moving vehicle having the load bed, and the right side of the device faces the rear of a moving vehicle having the load bed. The non-limiting arrangement of the left side toward the front of the vehicle provides for a higher number of contact points on the front face of the tarp 402, and has been observed to reduce the turbulence, agitation, and wear on the tarp 402. The non-limiting arrangement of the fixed bend ribs 1202, 1204 toward the rear of the vehicle provides for a more convenient loading arrangement, where the operator moves the fixed bend ribs 1202, 1204 to open and close the device 1200

FIG. 13 is a schematic diagram of a covering device 1300 having a securing flap 1302. In certain embodiments, the right side of the device 1300 in FIG. 13 faces the rear of a vehicle having the load deck. The flap 1302 is free to move during loading of the device, and includes a number of securing points to fix the flap 1302 down at loading. The use of the flap 1302, where present, covers the lower rear portion of the device 1300, which has been observed to reduce the turbulence, agitation, and wear on the tarp 402 for certain applications depending upon the air flow and speed over the load bed area. The use of the flap 1302 is optional and non-limiting.

The portion of the device 1300 that is lower and rear depends upon the application and where the air flow occurs on the device 1300. An example lower area includes at least the lower one-half, lower one-third, and/or lower one-quarter of the device 1300. Example rear areas include the rear one-half, rear one-third, rear one-fourth, and/or rear one-sixth of the device 1300. The flap 1302 may cover more area, including potentially all the way to the top of the tarp 402 in certain embodiments. The flap 1302 may be secured to the tarp 402, in one example at places that are rigid and supported under the tarp 402, or in places that due to the air flow and/or tarp arrangement are rigid and unlikely to move. An example location includes along one of the ribs on the side of the tarp 402, and along the region where the tarp 402 transitions from the top of the load to the side of the load (seam along the rib bends, where present) as shown in FIG. 13. Other arrangements, including fixing the flap 1302 at a point forward on the tarp 402 such that turbulent flapping is not likely to occur, are contemplated herein. In one example, two flaps 1302 are provided, one to each side of the tarp 402. In certain embodiments, a single flap 1302 extends across the tarp 402 to cover both sides. In certain embodiments, a single flap 1302 on one side is sufficient—for example where a load bed has a wall or support on one side but not on the other.

The schematic flow descriptions which follow provides an illustrative embodiment of performing procedures for operating a cover device. Operations illustrated are understood to be exemplary only, and operations may be combined or divided, and added or removed, as well as re-ordered in whole or part, unless stated explicitly to the contrary herein.

A procedure includes an operation to pull a ribbed cover device over a load, and an operation to position end ribs of the ribbed cover device flat against a load bed. The procedure further includes an operation to secure the ribbed cover device at a single position. An example operation to secure the ribbed cover device at a single position includes positioning a load strap in a securing configuration. Example and non-limiting securing configurations include a loop provided in a pull strap, a cover loop defined by a cover of the ribbed cover device, an upper surface of a securing extension coupled to one of the end ribs, and/or a passage defined by a cover loop and an upper surface of a securing extension coupled to one of the end ribs. In certain embodiments, the operation to pull the ribbed cover device over the load includes pulling a pull strap coupled to one of the end ribs, and in certain embodiments includes pulling a pull strap coupled to an end rib coupled to the securing extension.

Non-limiting examples of a means for laying end rib members flat against a load bed in a deployed position are described. An example means includes providing an end rib member with a fixed bend such that the rib member having the fixed bend lays flat on the load bed at positions beyond the fixed bend. Another example means further includes providing an end rib member with a branch, and an additional rib coupled to the end rib member at the branch. An example additional rib includes a fixed bend in the additional rib such that the additional rib lays flat on the load bed at positions beyond the fixed bend of the branch.

Non-limiting examples of a means for laying the rib members substantially flat in a stored position are described. An example means includes providing a hinge box hole progression, the hinge box holes defining pivot positions for the rib members, such that the hinge box hole progression is monotonically rising for straight rib members (straight in the plane perpendicular to the structural plates of the hinge boxes), and with holes positioned such that rib members having a fixed bend lay on top of the straight rib members in the stored position. An example means includes an end member having a perpendicular fixed bend. A still further example means includes positioning a hole and selecting a dog-leg length for a terminal rib member such that the rib member lays flat on a load bed in the deployed position, and lays on top of the rib member stack in the stored position. An alternative example means includes a non-perpendicular fixed bend, and selection of a hole position and dog-leg length such that the rib member lays flat on a load bed in the deployed position, and lays on top of the rib member stack in the stored position.

Non-limiting examples of a means for securing the load covering device with a single load strap are described. An example means includes providing a pull strap having a loop therein sized for receiving a load strap therethrough. An example means includes providing metal angle and/or metal grooves for receiving the deployed end ribs at one or more positions around the perimeter of the deployed load covering device. An example means includes providing a securing extension coupled to one of the end ribs, the securing extension structured to receive a load strap thereupon. Another example means includes an integral tarp loop and/or pull strap loop structured to form a securing passage therethrough in cooperation with the securing extension.

As is evident from the figures and text presented above, a variety of embodiments according to the present disclosure are contemplated.

An example set of embodiments is an apparatus including two opposing hinge boxes, each of the hinge boxes having a pair of structural plates. Each one of the pair of the structural plates has a matched progression of holes, the holes including two terminal holes (the holes at each end) and at least one central hole. The apparatus further includes a number of rib members, each rib member having two ends, where each of the two ends is interposed between, and pivotally coupled to, the pair of structural plates of one of the two opposing hinge boxes, and where the two ends of each of the rib members are positioned at corresponding holes of the matched progression of holes in each of the hinge boxes. One of the rib members, having ends positioned at one of the terminal holes in each of the hinge boxes, is a terminal rib member. The terminal rib member includes a fixed bend, the fixed bend being in a plane parallel to the structural plates.

Certain embodiments of the apparatus further include one or more of the following features: the vertically highest one of all of the holes is not one of the terminal holes; each of the hinge boxes further including a friction reducing sleeve; each friction reducing sleeve including a friction reducing material positioned between a pair of the structural plates; a friction reducing material positioned between the pair of the structural plates throughout a contact surface area, the contact surface area being an area of the structural plates that has a rib adjacent thereto at any position in the operating range of the apparatus, where the operating range includes any position between fully open and fully closed, inclusive; and/or the friction material including neoprene, poly-tetra-fluro-ethylene (Teflon®), plastic, and/or a material having a lower hardness value than the rib material.

Certain additional or alternative embodiments of the apparatus further include one or more of the following features: the rib members made of aluminum, the matched progression of holes being a monotonically rising hole progression, except one of the terminal holes, corresponding to the terminal rib member, being lower than an adjacent hole; each of the rib members attached to at least one adjacent rib member with at least two support straps; each of the rib members attached to at least one adjacent rib member with at least two support straps where the two support straps are spaced, in a load width direction (or in a direction perpendicular to the plane of the structural plates), by at least 30% of a width of the apparatus; the apparatus further including a pair of diagonal supporting straps, each of diagonal supporting straps being coupled to each of the rib members at a progressing position, the progressing position comprising a load width direction (or a direction perpendicular to the plane of the structural plates); a pull strap coupled to one of the end rib members; a pull strap coupled to the terminal rib member; the pull strap including a loop sized to accommodate a load strap; the terminal rib member further including a branch and additional rib member pivotally coupled thereto, wherein the additional rib member lays flat against a load bed when the apparatus is in a fully closed position (or a fully deployed position); and/or where the rib members lay substantially flat when the apparatus is in a fully opened position (or a fully stored position).

Certain additional or alternative embodiments of the apparatus further include one or more of the following features: the apparatus including a securing extension coupled to one of the end rib members; the apparatus including a securing extension coupled to the terminal rib member; the apparatus further including an integral cover coupled to a number of the rib members and structured to open and close with the apparatus; the apparatus further including the integral having a loop, the loop cooperating with the securing extension to form a passage therethrough; the apparatus where the passage is sized for a load strap; the progression of holes including at least five (5) holes; the progression of holes including eight (8) holes; a load fixing member coupled to each of the hinge boxes; a pocket stake coupled to each of the hinge boxes; where each of the rib members includes a rectangular cross-section; each of the end rib members including a flat surface directly facing a load bed when the apparatus is in the fully closed (or fully deployed) position; the apparatus further including a metal angle and/or a metal groove, where the metal angle and/or the metal groove is coupled to a load bed and structured to receive at least a portion of the end rib members when the apparatus is in the fully open position.

In certain embodiments, the apparatus is sized to fit: a flatbed for a truck, a pickup truck bed, a cylindrical load, a metal coil, an aluminum coil, a steel coil, two metal coils, two aluminum coils, two steel coils, and a boat cockpit area.

Another example set of embodiments is a method including: pulling a ribbed cover device over a load, positioning end ribs of the ribbed cover device flat against a load bed, and securing the ribbed cover device at a single position. In certain embodiments, the method includes securing the ribbed cover device by positioning a load strap in a securing configuration, the securing configuration including: a loop provided in a pull strap, a cover loop defined by a cover of the ribbed cover device, an upper surface of a securing extension coupled to one of the end ribs, and/or a passage defined by a cover loop and an upper surface of a securing extension coupled to one of the end ribs. In certain embodiments, the pulling includes pulling a pull strap coupled to one of the end ribs.

While the invention has been illustrated and described in detail in the drawings and foregoing description, the same is to be considered as illustrative and not restrictive in character, it being understood that only certain exemplary embodiments have been shown and described. Those skilled in the art will appreciate that many modifications are possible in the example embodiments without materially departing from this invention. Accordingly, all such modifications are intended to be included within the scope of this disclosure as defined in the following claims.

In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. An apparatus, comprising:
two opposing hinge boxes, each of the hinge boxes comprising a pair of structural plates, each of the pair of structural plates defining a matched progression of holes therein, wherein the matched progression of holes comprises two terminal holes and at least one central hole;
a plurality of rib members, each rib member having two ends, wherein each of the two ends is interposed between, and pivotally coupled to, the pair of structural plates of one of the two opposing hinge boxes, and wherein the two ends of each of the rib members are positioned at corresponding holes of the matched progression of holes in each of the hinge boxes; and
wherein a rib member having ends positioned at one of the terminal holes in each of the hinge boxes comprises a terminal rib member, the terminal rib member comprising a fixed bend, the fixed bend being in a plane parallel to the structural plates.

2. The apparatus of claim 1, wherein the vertically highest of the progression of holes is not one of the terminal holes.

3. The apparatus of claim 2, wherein one of the central rib members adjacent to the terminal rib member further comprises a second fixed bend, the second fixed bend being in a plane parallel to the structural plates.

4. The apparatus of claim 3, wherein the matched progression of holes comprises a monotonically rising hole progression, except the holes corresponding to the terminal rib member having the fixed bend, and the hole corresponding to the central rib member adjacent to the terminal rib member and having the second fixed bend.

5. The apparatus of claim 4, further comprising:
an integral cover coupled to a plurality of the rib members and structured to open and close with the apparatus;
the terminal rib member structured to be positioned at a rear position, and wherein an end rib member opposite the terminal rib member is structured to be positioned at a front position;
a second rib member adjacent to the end rib member opposite the terminal rib member and a third rib member adjacent to the second rib member; and
wherein the second rib member and the third rib member each further comprise a pivotally coupled branched rib member.

6. The apparatus of claim 5, further comprising a securing flap coupled to each side of the integral cover, each securing flap structured to cover a lower rear area of the integral cover in a secured position, and each securing flap comprising a plurality of securing holes.

7. The apparatus of claim 3, wherein the fixed bend and the second fixed bend are both positioned between the structural plates.

8. The apparatus of claim 1, wherein each of the hinge boxes further comprise a friction reducing sleeve, each friction reducing sleeve comprising a friction reducing material interposed between the structural plates over a contact surface area, the contact surface area comprising an area of the structural plates that has a rib adjacent thereto at any position in the operating range of the apparatus, the operating range comprising any position between fully open and fully closed, inclusive.

9. The apparatus of claim 1, wherein the rib members comprise aluminum.

10. The apparatus of claim 1, wherein each of the rib members is attached to an adjacent rib member with at least two support straps.

11. The apparatus of claim 10, wherein the two support straps are spaced in a load width direction by at least 30% of a width of the apparatus.

12. The apparatus of claim 1, further comprising a pull strap coupled to one of the terminal rib member, and an end rib member opposite the terminal rib member.

13. The apparatus of claim 12, wherein the pull strap further comprises a loop sized to accommodate a load strap.

14. The apparatus claim 1, wherein each of the terminal rib member and an end rib member opposite the terminal rib member lay substantially flat when the apparatus is in a fully opened position.

15. The apparatus claim 14, further comprising a securing extension coupled to one of the terminal rib member and the end rib member opposite the terminal rib member.

16. The apparatus of claim 1, further comprising an integral cover coupled to a plurality of the rib members and structured to open and close with the apparatus.

17. The apparatus claim 1, further comprising a load fixing member coupled to each of the hinge boxes, the load fixing member comprising one of a pocket stake and a stake pocket.

16. The apparatus of claim 1, wherein the end rib members include a flat surface directly facing a load bed when the apparatus is in the fully closed position.

17. The apparatus of claim 16, further comprising one of a metal angle and a metal groove, the one of the metal angle and the metal groove coupled to a load bed and structured to receive at least a portion of the end rib members when the apparatus is in the fully closed position.

18. A method, comprising:
pulling a ribbed cover device over a load;
positioning end ribs of the ribbed cover device flat against a load bed; and
securing the ribbed cover device at a single position.

19. The method of claim 18, wherein the securing further comprising positioning a load strap in a securing configuration, the securing configuration comprising a configuration selected from the configurations consisting of:
a loop provided in a pull strap;
a cover loop defined by a cover of the ribbed cover device; and
an upper surface of a securing extension coupled to one of the end ribs; and
a passage defined by a cover loop and an upper surface of a securing extension coupled to one of the end ribs.

20. The method of any one claim 18, wherein the pulling comprises pulling a pull strap coupled to one of the end ribs.

21. A load covering device, comprising:
a pivotally deploying ribbed covering device having two hinge boxes and a plurality of rib members; and
a means for laying end rib members flat against a load bed in a deployed position.

22. The load covering device of claim 21, further comprising a means for securing the load covering device with a single load strap.

23. The load covering device of claim 21, further comprising a means for laying the rib members substantially flat in a stored position.

26. The load covering device of claim 23, further comprising a means for deploying or storing the load covering device by applying force to an end one of the rib members.

27. The load covering device of claim 23, wherein the means for laying end rib members flat against a load bed in a deployed position further comprises an end one of the rib members having a fixed bend.
